(19) United States
(12) Patent Application Publication
(10) Pub. No.: US 2006/0203507 A1
(43) Pub. Date: Sep. 14, 2006

(54) Illumination device

(76) Inventor: Ulrich Sander, Rebstein (CH)

Correspondence Address: HODGSON RUSS LLP, ONE M & T PLAZA, SUITE 2000, BUFFALO, NY, 14203-2391, US

(21) Appl. No.: 11/369,509

(22) Filed: Mar. 7, 2006

(30) Foreign Application Priority Data
Mar. 9, 2005 (DE) 10 2005 010 887.3

(51) Int. Cl. G02B 6/00

(52) U.S. Cl. 362/551

(57) ABSTRACT

An illumination device for a microscope, having a light source and a fiber-optic cable device comprising an input end and an output end, light emitted from the light source entering the input end of the fiber-optic cable device and emerging at the output end of the fiber-optic cable device, the fiber-optic cable device comprising one or more optical fibers, the one or more optical fibers each being embodied with a fiber body through each of which at least two channels extend parallel to the respective center axes z of the optical fibers.

### CROSS REFERENCE TO RELATED APPLICATIONS

This application claims priority of the German patent application 10 2005 010 887.3 filed Mar. 9, 2005 which is incorporated by reference herein.

### FIELD OF THE INVENTION

The present invention relates to an illumination device for a microscope having a light source and a fiber-optic cable, and to a microscope incorporating such an illumination device.

### BACKGROUND OF THE INVENTION

Various types of illumination systems for microscopes are known. These known illumination systems are either installed on the side of the microscope as an oblique illumination system or, to reduce the illumination angle, incorporated directly into the microscope. For example, it is possible for the illumination beam path to be guided through the main objective or also through further optical components of the microscope.

The light sources used are, for example, halogen lamps. It is also known to provide for a spectral selection of the light emitted by the light sources. For example, it is possible to filter out damaging UV or IR radiation. In this connection, lasers are also used as light sources.

In the context of conventional illumination devices for microscopes, it is likewise known to use fiber-optic cable devices in order to direct the light emitted by a light source onto the specimen to be observed. Such fiber-optic cable devices comprise at least one optical fiber that is embodied respectively as an elongated cylindrical body of a certain length.

A disadvantage of such fiber-optic cables or optical fibers, however, is that the light emerging from the fiber, for example laser light, proceeds in highly divergent fashion. The divergent emergence of light from a conventional fiber-optic cable device is illustrated in FIG. 4. It is evident that light emerging from a conventional fiber-optic cable device 41 having an optical axis 41a diverges at output end 41b of fiber-optic cable device 41. If the divergent light is to be used in the context of an illumination device for a microscope, this divergence must be corrected with the aid of an imaging optical system. The imaging optical system is depicted schematically in FIG. 4 by way of the two lenses 42, 43. What results is a light bundle 40 having a relative large diameter.

Imaging lenses with a very large diameter are necessary because of the large divergence angles (approximately 60 to 80 degrees) that typically occur, thus increasing the overall size of the microscope. In the case of surgical microscopes in particular, however, it is desirable to use components that are as physically small as possible.

In the context of microscopes using glass-fiber illumination or fiber-optic cable illumination, there is a need to make available the smallest possible divergence angle upon emergence of the light from the fiber-optic cable, so that for the reasons mentioned above, a microscope that is as physically small and compact as possible can be implemented.

### SUMMARY OF THE INVENTION

This goal is achieved by way of an illumination device wherein a fiber-optic cable of the device comprises at least one optical fiber having a longitudinal central axis and a fiber body through which a plurality of channels extend parallel to or along the central axis of the optical fiber. The goal is also achieved by a microscope equipped with such an illumination device.

As a result of the embodiment according to the present invention of the optical fibers of a fiber-optic cable device, having in each case at least two channels that extend parallel to the respective center axis of the optical fibers and through them, light emerging from the fiber-optic cable device is converged and not, as was the case with conventional fiber-optic cable devices, diverged. With an illumination device according to the present invention, light emitted from the light source can therefore be used in particularly accurately targeted fashion. In particular, it is possible to dispense with an imaging optical system placed after the fiber-optic cable device, or to make such an optical system substantially smaller than in conventional apparatuses.

It proves to be favorable that the one or more optical fibers each comprise a central channel that extends along the center axis z of the respective optical fibers. The formation of such a central channel makes it possible for the intensity of a light impinging upon the fiber-optic cable device, in particular laser light, to be concentrated in the region of the central channel.

According to a particularly preferred embodiment of the illumination device according to the present invention, at least two channels of the one or more optical fibers are at an identical radial spacing rᵢ (i=0, 1, 2, 3, . . . ) from the respective center axis z of the optical fibers. A particularly pronounced concentration of a light beam traversing the respective fibers is achievable, in particular, when channels arranged in this fashion coact with a central channel, so that a convergent beam path is produced at the end of the respective optical fibers or fiber-optic cable device.

This effect becomes apparent especially when the at least two channels of the one or more optical fibers form, in a cross section of the at least one optical fiber, at least one ring made up of channels spaced apart from one another (in which context the respective channels forming the ring extend parallel to the central channel). The spacings of the respectively adjacent channels in a ring of this kind can preferably be identical in size, but can also be different.

It is useful if at least one channel exhibits a circular or annular cross section. As a rule, the respective channels will each exhibit a circular cross section. It is also conceivable, however, to introduce annular channels into an optical fiber body. For example, it is conceivable to provide a central channel together with at least one annular channel that completely surrounds it concentrically.

According to a particularly preferred embodiment of the illumination device according to the present invention, the one or more optical fibers comprise a central channel, having a diameter D, that extends along center axis z of the respective optical fibers, as well as a number of channels extending parallel to the central channel that are each at the same spacing rᵢ (i=1, 2, 3, . . . ) from the central channel and have a diameter d, where D>d. As a result of this feature, with a suitable selection of substances and materials that are present in the respective channels, the channels extending parallel to the central channel have an effectively higher refractive index than the central channel. This produces particularly favorable superimposition effects, such that a laser beam impinging upon an optical fiber of this kind is concentrated in the central channel. In particular, it is possible to generate a Gaussian profile for the light beam emerging from the respective fibers or from the fiber-optic cable device.

According to a further preferred embodiment, it is likewise possible for the channels extending parallel to the central channel to form a honeycomb structure. The channels surrounding the central channel can each be embodied in cross section as a regular hexagon, with thin walls remaining between the individual channels. These thin walls, according to this embodiment, form the optical fiber bodies. The honeycomb structure can extend over the entire cross section of the optical fibers or only over a region, for example a region directly surrounding the central channel.

It is particularly preferred that at least one of the at least two channels of the respective optical fibers is filled with a gas, in particular air or a noble gas. With this feature it is easy to ensure that the optical refractive index inside the channels is lower than in the material of the fiber body surrounding the channels, which material is preferably constituted from a suitable substance such as glass, quartz, or plastic. In optical fibers embodied in this fashion, light guidance is accomplished, inter alia, by continued total reflection within the gas-filled channels.

If the channels are filled with a noble gas, for example xenon, it is possible in particular to avoid wavelength shifts in the light impinging upon the respective optical fibers as a result of the Raman effect. The Raman effect can also be avoided, for example, by the fact that an at least partial vacuum is constituted in at least one of the at least two channels.

According to a particularly preferred embodiment of the illumination device according to the present invention, the light source is embodied as an LED, incandescent lamp, gas discharge lamp, or laser light source. Such light sources allow the above-described effects of concentrating light and maximizing intensity within or in the vicinity of the central channel, and the convergence of emerging light associated therewith, to be achieved in particularly effective fashion.

It is furthermore possible in this connection, in particular, to configure the central channel and/or the further channels extending parallel to it with a diameter of approximately one micrometer. The configuration of channels with such dimensions can result in a red shift of photons that are passing through those channels. A red shift of this kind can compensate for a blue shift such as the one caused by the aforementioned Raman effect.

The use of an illumination device according to the present invention proves to be advantageous in particular in surgical microscopes, for example stereomicroscopes.

It is understood that the features recited above and those yet to be explained below can be used not only in the respective combination indicated, but also in other combinations or in isolation, without leaving the context of the present invention.

### BRIEF DESCRIPTION OF THE DRAWINGS

The invention will now be explained further with reference to the appended drawings, in which:

FIG. 1 is a schematic side view of a microscope with a preferred embodiment of the illumination device according to the present invention;

FIG. 2a is a schematic sectioned view of a first preferred embodiment of an optical fiber that is usable in an illumination device according to the present invention;

FIG. 2b is a schematic sectioned view of a second preferred embodiment of an optical fiber that is usable in an illumination device according to the present invention;

FIG. 2c is a schematic sectioned view of a third preferred embodiment of an optical fiber that is usable in an illumination device according to the present invention;

FIG. 3 is a schematic sectioned side view of a preferred embodiment of the illumination device according to the present invention; and

FIG. 4 is a schematic sectioned side view of a conventional fiber-optic cable illumination device.

### DETAILED DESCRIPTION OF THE INVENTION

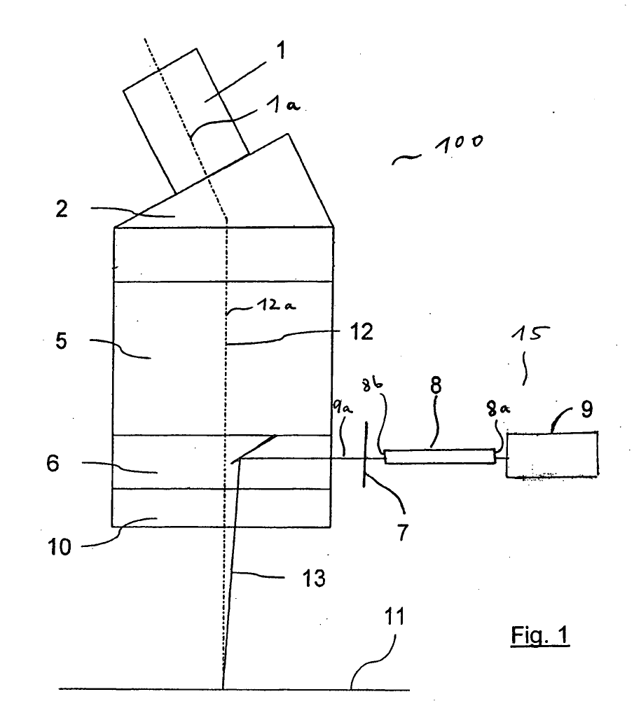

FIG. 1 schematically depicts the construction of a microscope labeled in its entirety with the number 100.

An observation beam path 12a is guided, through a tube 2 having an eyepiece 1, an (optional) zoom system 5, and a main objective 10, along an optical axis 12 of main objective 10. In tube 2, a deflection of the observation beam path in the direction of optical axis 1a of eyepiece 1 is performed. In the case of a stereoscopic embodiment of the microscope, the right and left observer beam paths are located behind one another in the schematic side view of FIG. 1. In this case tube 2 is embodied correspondingly as a binocular tube having two eyepieces 1.

A specimen (not depicted) is located at the intersection point of optical axis 12 with a specimen plane 11.

A preferred embodiment of the illumination device according to the present invention is labeled in its entirety with the number 15. It comprises a light source 9, a fiber-optic cable device 8 comprising at least one optical fiber according to the present invention, and an imaging optical system 7. In the interest of illustrative simplicity, all the components 7, 8, 9 are depicted only schematically.

A light generated by light source 9 is directed, as illuminating light 13, via fiber-optic cable device 8 and imaging optical system 7 and a deflection element 6, onto the specimen, for example a patient's eye, that is to be observed. A longitudinal axis of fiber-optic cable device 8 and of light source 9 is labeled 9a.

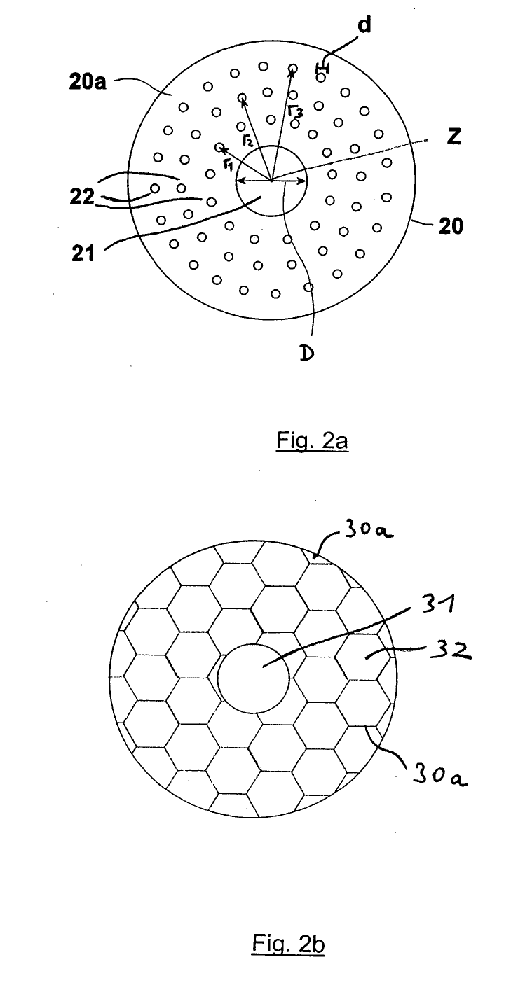

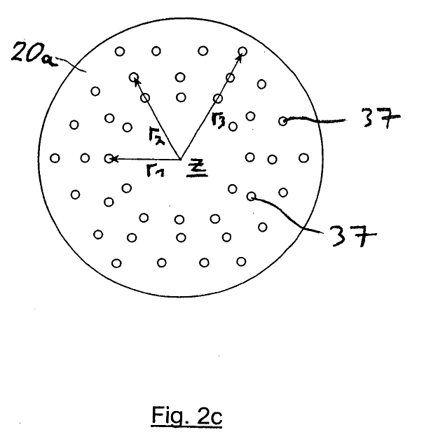

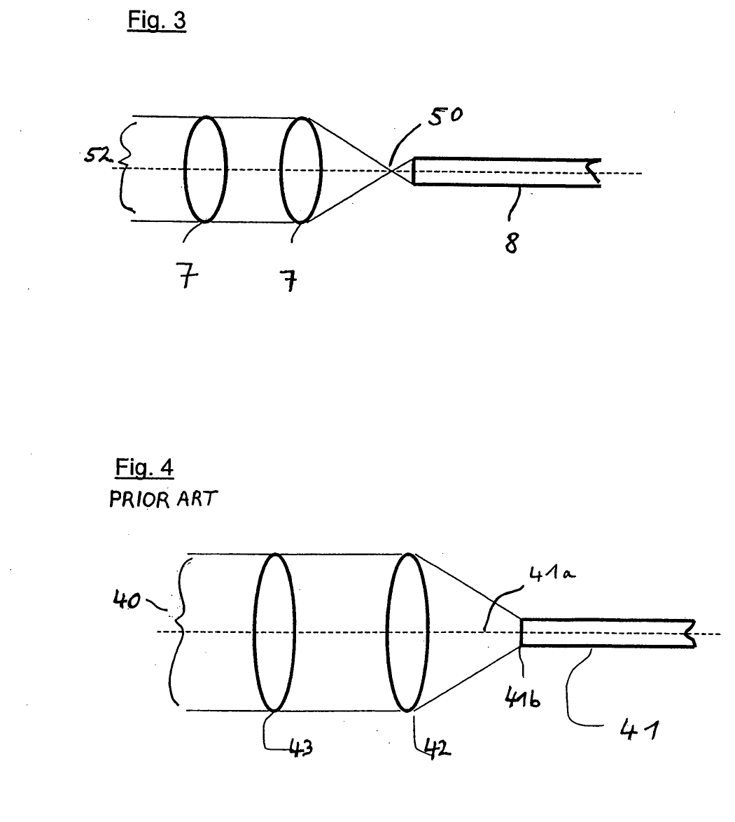

The optical fibers embodied according to the present invention are explained below with reference to FIGS. 2a, 2b, 3c, and 3.

FIG. 2a depicts a first preferred embodiment of an optical fiber usable according to the present invention. The fiber is here labeled 20. It comprises a fiber body 20a in which are embodied a central channel 21 extending along a center axis z, and a number of non-central channels 22 extending parallel to that central channel. It is evident that channels 22 form respective concentric rings around central channel 21, the channels of each ring being at the same radial spacing r1, r2, r3 from axis z. Channels 21, 22 are filled with a gas, in particular air. Fiber body 20a is made of a suitable glass, quartz, or plastic. The optical refractive index of channels 21, 22 is lower than the optical refractive index of fiber body 20a.

It is further apparent that diameter D of central channel 21 is larger than diameter d of the respective channels 22 that extend parallel to central channel 21.

The result of this is that channels 22 exhibit an effectively higher refractive index than central channel 22.

The overall result of the above-described configuration of the refractive indices is that upon impingement of a light beam on optical fiber 20, a superimposition occurs in which the light beam, or the intensity of the light beam, is concentrated in central channel 21. Light emerging from an optical fiber of this kind exhibits a Gaussian profile whose maximum lies at the center of the central channel. Light emerging from such a fiber is moreover convergent, as further described below with reference to FIG. 3.

Be it noted for the sake of completeness that the channel structure depicted in cross section in FIG. 2a extends through the entire optical fiber 20. Be it noted further that the size correlations depicted, in particular between the channel diameter and fiber diameter, are not necessarily realistic but serve merely for graphic illustration. The same applies to FIGS. 2b and 2c that will now be explained.

A second preferred embodiment of an optical fiber usable according to the present invention is depicted in FIG. 2b. A central channel that extends along center axis z of the optical fiber is here labeled 31. This channel 31 is surrounded by non-central channels 32 of substantially hexagonal configuration, which together form a honeycomb structure. Thin wall structures are configured between the respective individual channels 32. This wall structure is part of a fiber body that is here labeled 30a. The honeycomb structure either can extend over the entire cross section of the fiber body, or it is also conceivable to embody outer regions of the fiber body with thicker walls, or continuously from a suitable material.

Fiber body 30a, or the walls between channels 32, have in each case a higher optical refractive index than channels 31, 32, which are filled with a gas, for example air. Central channel 31 furthermore has a larger diameter than channels 32 surrounding it (“diameter” being used in a broad sense not limited to circular channel cross-section), so that here again channels 32 exhibit an effectively higher refractive index than central channel 31. This results overall in light guidance effects similar to those already described with reference to FIG. 2a.

A further preferred embodiment of an optical fiber usable according to the present invention is depicted in FIG. 2c. The fiber corresponds in certain aspects to the fiber according to FIG. 2a, so that the same reference characters are used in some cases. The fiber according to FIG. 2c differs essentially from the one depicted in FIG. 2a in that central channel 21 is dispensed with. Channels 37 furthermore form respective hexagonal structures or rings around center axis z of the optical fiber. With a channel structure of this kind in an optical fiber it is again possible to achieve light guidance effects similar to those already described with reference to FIGS. 2a and 2b.

As already mentioned, what occurs at the output end of a glass fiber according to the present invention is not a divergence of the emerging light but rather a convergence. This effect is illustrated in FIG. 3.

Here a fiber-optic cable device comprising a plurality of glass fibers according to the invention is once again labeled 8. It is evident that light emerging from fiber-optic cable device 8 at first converges to a focal point 50, and only thereafter diverges. The result of this is that an imaging optical system for correcting this divergence can be of substantially smaller dimensions as compared with conventional systems. An imaging optical system of this kind is illustrated (schematically) by way of lenses 7. A light bundle 52 emerging from this imaging optical system has a substantially smaller diameter as compared with the existing art.

Parts List

1 Eyepiece
1a Optical axis of eyepiece
2 Tube
5 Zoom system
6 Deflection unit
7 Imaging optical system
8 Fiber-optic cable device
8a Inputend
8b Output end
9 Light source
9a Longitudinal axis of fiber-optic cable device
10 Main objective
11 Specimen plane
12 Optical axis of main objective
12a Observation beam path
13 Illumination beam path
15 Illumination device
20 Optical fiber
20a Fiber body
21, 22 Channel
30 Optical fiber
30a Fiber body
31,32 Channel
37 Channel
40 Light bundle
41 Fiber-optic cable device
41a Optical axis
41b Output end of fiber-optic cable device
42, 43 Lenses
50 Focal point
52 Light bundle
100 Microscope
z Center axis
r1, r2, r3 Radial spacings

What is claimed is:

1. An illumination device for a microscope, the illumination device comprising:
a light source; and
a fiber-optic cable including an input end and an output end, light emitted from the light source entering the input end of the fiber-optic cable and emerging at the output end of the fiber-optic cable;
wherein the fiber-optic cable comprises at least one optical fiber having a longitudinal central axis and a fiber body through which a plurality of channels extend parallel to or along the central axis of the optical fiber.

2. The illumination device according to claim 1, wherein the plurality of channels includes a central channel that extends along the central axis of the optical fiber.

3. The illumination device according to claim 1, wherein the plurality of channels includes a plurality of non-central channels that extend parallel to the central axis of the optical fiber and are at an identical radial spacing from the central axis of the optical fiber.

4. The illumination device according to claim 3, wherein the plurality of non-central channels form, in a cross section of the at least one optical fiber, at least one ring made up of channels spaced apart angularly from one another.

5. The illumination device according to claim 1, wherein at least one of the plurality of channels has a circular or annular cross-sectional shape.

6. The illumination device according to claim 2, wherein the central channel has a circular or annular cross-sectional shape.

7. The illumination device according to claim 1, wherein the at least one optical fiber includes a central channel that extends along the central axis of the optical fiber and a plurality of non-central channels extending parallel to the central axis, the plurality of non-central channels being at an identical radial spacing from the central axis and having a diameter (d), wherein the central channel has a diameter (D) such that D>d.

8. The illumination device according to claim 7, wherein the plurality of non-central channels form a honeycomb structure.

9. The illumination device according claim 1, wherein at least one of the plurality of channels of the at least one optical fiber is filled with a gas.

10. The illumination device according to claim 9, wherein the gas is air.

11. The illumination device according to claim 9, wherein the gas is a noble gas.

12. The illumination device according to claim 1, wherein an at least partial vacuum is constituted in at least one of the plurality of channels.

13. The illumination device according to claim 1, wherein the light source is a laser light source.

14. A microscope comprising:
a main objective through which a specimen is observed;
an illumination device providing light for illuminating a specimen to be observed, wherein the illumination device comprises:
a light source; and
a fiber-optic cable including an input end and an output end, light emitted from the light source entering the input end of the fiber-optic cable and emerging at the output end of the fiber-optic cable;
wherein the fiber-optic cable comprises at least one optical fiber having a longitudinal central axis and a fiber body through which a plurality of channels extend parallel to or along the central axis of the optical fiber.

15. The microscope according to claim 14, wherein the microscope is a stereomicroscope.
